(19) United States
(12) Patent Application Publication
(10) Pub. No.: US 2026/0005837 A1
(43) Pub. Date: Jan. 1, 2026

(54) SECURE AUTHORIZATION OF THE HELM CHART

(71) Applicant: Dell Products L.P., Round Rock, TX (US)

(72) Inventors: MAXIM BALIN, Gan-Yavne (IL); CHRISTODOULOS PSALTIS, Trikala (GR); SHREE RATHINASAMY, Round Rock, TX (US)

(21) Appl. No.: 18/756,251

(22) Filed: Jun. 27, 2024

(51) Int. Cl. H04L 9/08; H04L 9/32

(52) U.S. Cl. CPC H04L 9/0825; H04L 9/3247

(57) ABSTRACT

Methods and systems for managing operation of a deployment are disclosed. The operation may be managed by securing authorization of a configuration package and artifacts for the deployment. The authorization may be secured by secure transfer of the configuration package, the artifacts, and the private key from a vendor to the customer. The public key may be used to facilitate the secure transfer. On release of the configuration package, the artifacts, and the private key to the customer, the private key may be used to authorize deployment of an artifact to a data processing system.

### FIELD

Embodiments disclosed herein relate generally to managing operation of a deployment. More particularly, embodiments disclosed herein relate to securely authorizing a desired service chart and at least one artifact to a requestor.

### BACKGROUND

Computing devices may provide computer-implemented services. The computer-implemented services may be used by users of the computing devices and/or devices operably connected to the computing devices. The computer-implemented services may be performed with hardware components such as processors, memory modules, storage devices, and communication devices. The operation of these components and the components of other devices may impact the performance of the computer-implemented services.

### BRIEF DESCRIPTION OF THE DRAWINGS

Embodiments disclosed herein are illustrated by way of example and not limitation in the figures of the accompanying drawings in which like references indicate similar elements.

FIG. 1 shows a diagram illustrating a system in accordance with an embodiment.

FIGS. 2A-2F show data flow diagrams illustrating operation of a system in accordance with an embodiment.

FIG. 3 shows a flow diagram illustrating a method in accordance with an embodiment.

FIG. 4 shows a block diagram illustrating a data processing system in accordance with an embodiment.

### DETAILED DESCRIPTION

Various embodiments will be described with reference to details discussed below, and the accompanying drawings will illustrate the various embodiments. The following description and drawings are illustrative and are not to be construed as limiting. Numerous specific details are described to provide a thorough understanding of various embodiments. However, in certain instances, well-known or conventional details are not described in order to provide a concise discussion of embodiments disclosed herein.

Reference in the specification to “one embodiment” or “an embodiment” means that a particular feature, structure, or characteristic described in conjunction with the embodiment can be included in at least one embodiment. The appearances of the phrases “in one embodiment” and “an embodiment” in various places in the specification do not necessarily all refer to the same embodiment.

References to an “operable connection” or “operably connected” means that a particular device is able to communicate with one or more other devices. The devices themselves may be directly connected to one another or may be indirectly connected to one another through any number of intermediary devices, such as in a network topology.

In general, embodiments disclosed herein relate to methods and systems for managing operation of a deployment. The deployment may be managed by securing authorization of a configuration package and artifacts that are included in the deployment.

The authorization of the configuration package and the artifacts may first be secured by a vendor who supplies components of the deployment. A customer, who will receive the components, may be given a public key and a private key. The public key may be shared openly with the customer, but the private key may be transferred through a secure location. To transfer the configuration package and the artifacts, the vendor may require confirmation of a customer copy of the public key. Once the customer copy of the public key is confirmed, then the configuration package and the artifacts may be transferred to the customer.

Once the configuration package and the artifacts are part of the deployment, use of an artifact may require decryption and verification to be deployed to a data processing system. Decryption may be performed with the private key, which may be stored securely by the customer. The decryption and verification may prevent unauthorized use of the artifact. In this way, components of the deployment, including the configuration package and the artifacts, may be secured.

In an embodiment, a method for managing operation of a deployment is disclosed. The method may include (i) obtaining, from a requestor, a request for the deployment to provide a desired service; (ii) obtaining, based on the request, a desired service identifier for the requestor, the desired service identifier uniquely identifying the requestor and the desired service; (iii) obtaining, based on at least the desired service identifier, a public key and a private key; (iv) obtaining, using the public key and the private key, a secure and traceable data package; and (v) providing access to the secure and traceable data package to the requestor to enable at least a portion of the deployment to be configured to obtain an updated deployment that provides the desired service.

Obtaining the secure and traceable data package may include (i) obtaining, based on the desired service, a desired state chart for at least one artifact; (ii) obtaining, based on the desired service, the at least one artifact; (iii) signing, using the private key, the desired state chart and the at least one artifact to obtain a signed desired state chart and a signed at least one artifact; and (iv) encrypting, using the public key, at least the signed desired state chart and the signed at least one artifact to obtain the secure and traceable data package.

The method may further include providing, to the requestor, secure access to the private key to enable the secure and traceable data package to be decrypted.

Providing the secure access to the private key may include storing the private key in a secure location to be accessible only by the requestor.

The desired service identifier may associate the desired state chart, the public key, and the private key to the requestor.

The desired state chart may be a set of instructions for configuring, installing, and managing container applications.

The at least one artifact may include executable code, configurations, libraries, or container applications.

The secure and traceable data package may include a set of signed and encrypted artifacts and a signed and encrypted desired state chart.

In an embodiment, a non-transitory media is provided. The non-transitory media may include instructions that when executed by a processor cause the computer-implemented method to be performed.

In an embodiment, a data processing system is provided. The data processing system may include the non-transitory media and a processor, and may perform the computer-implemented method when the computer instructions are executed by the processor.

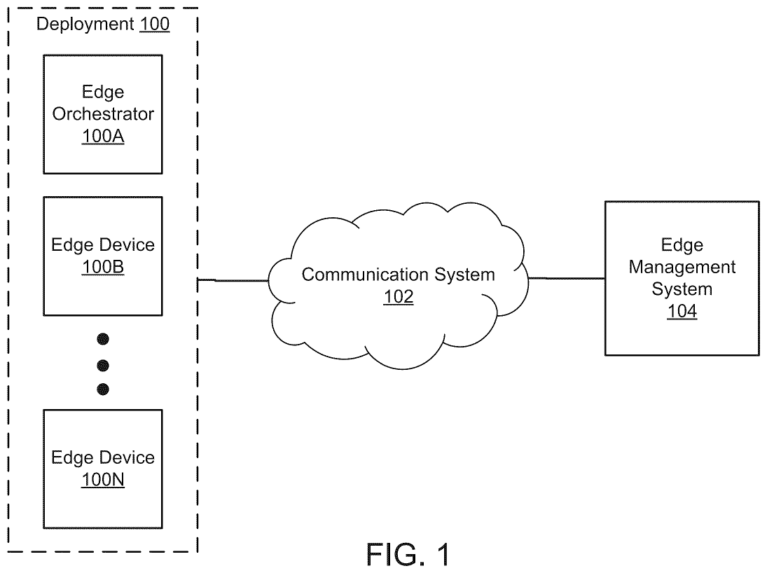

Turning to FIG. 1, a system in accordance with an embodiment is shown. The system may provide any number and types of computer implemented services (e.g., to user of the system and/or devices operably connected to the system). The computer implemented services may include, for example, data storage service, instant messaging services, etc.

To provide the computer implemented services, data processing systems may operate in particular manners. For example, hooks may be used to perform operations with selected applications. Hooks may be executable scripts that can be run at preselected times of a lifecycle of the deployment and may include configuration settings to use applications in the deployment.

However, risk may be present when the configuration settings remain unsecured in the deployment. For example, if a malicious actor gains access to the configuration settings, the configuration settings may be used to gain unauthorized access to a deployment. By unauthorized access to the deployment, computer implemented services may be impacted.

In general, embodiments disclosed here relate to systems and methods for managing operation of a deployment. The deployment may be managed by securing a configuration package (e.g., a helm chart or other data structure used in configuration/onboarding/etc.) and at least one artifact used by the deployment. The configuration package may include a collection of files used to manage the deployment. The collection of the files may include configuration setting used to run applications. The at least one artifact may include executable code, configurations, libraries, and/or container applications. The artifacts may be used to deploy applications and provide computer implemented services.

To secure the configuration package and the at least one artifact, a public key and a private key may be generated for the configuration package and the at least one artifact. The configuration package and the at least one artifact may be signed, using the private key, and encrypted, using the public key.

The configuration package, the at least one artifact, and the public key may be provided to an administrator of the deployment. While the public key may be shared openly with the administrator, a signed and encrypted configuration package and at least one signed and encrypted artifact may be transferred securely by requiring matching a copy of the public key to the administrator with the public key. With a match confirmed, the signed and encrypted configuration package and the at least one signed and encrypted artifact may be provided to the administrator.

To decrypt the signed and encrypted configuration package, the administrator may retrieve the private key from a secured location determined by the vendor. The administrator may decrypt the signed and encrypted configuration package to obtain a signed configuration package. The signed configuration package may be configured with the deployment. The signed configuration package may be configured by resolving dependencies and the artifacts so that the dependencies and the artifacts may be used by the signed configuration package in the deployment. After configuring, the private key may be secured in a local vault.

When a request for computer implemented services is made and/or to prepare to provide computer implemented services in the future, the private key may be retrieved from the local vault. In addition, the at least one signed and encrypted artifact may be selected. The at least one signed and encrypted artifact may be decrypted using the private key, verified, and deployed, based on instructions from the configuration package. Requiring decryption of the at least one signed and encrypted artifact may prevent unauthorized use of the at least one signed and encrypted artifact by a malicious actor.

To provide the above noted functionality, the system may include deployment 100 and edge management system 104. Each of these components is discussed below.

Edge management system 104 may configure edge devices 100B-100N to provide computer implemented services. Edge management system 104 may configure edge devices 100B-100N by providing a configuration package and at least one artifact to deployment 100. To reduce a likelihood of the configuration package and/or the at least one artifact from being used for unauthorized purposes, a security framework may be used that includes encryption and verification procedures.

Deployment 100 may provide desired computer implemented services. To do so, deployment 100 may include edge orchestrator 100A and edge device 100B-100N. Each of these components is discussed below.

Edge orchestrator 100A may manage edge devices 100B-100N. To manage the edge devices, edge orchestrator 100A may cooperate with edge management system 104. For example, edge orchestrator 100A may obtain artifacts and other information from edge management system 104 usable to modify the operation of edge devices 100B-100N. While interacting with edge management system 104 and edge devices 100B-100N, edge orchestrator 100A may participate in and help to enforce the security framework used to safeguard artifacts and other information used in managing the edge devices.

Edge device 100B-100N (e.g., any number) may provide computer implemented services. To provide the computer implemented services, edge devices 100B-100N may be configured in predetermined manners. Edge devices 100B-100N may cooperate with edge orchestrator 100A to facilitate such configuration through, for example, modification of software, hardware, and/or configuration settings.

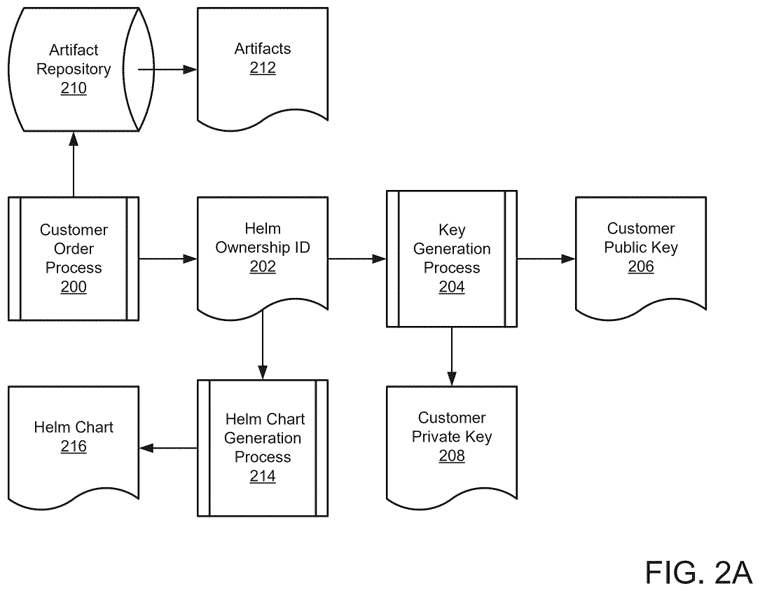

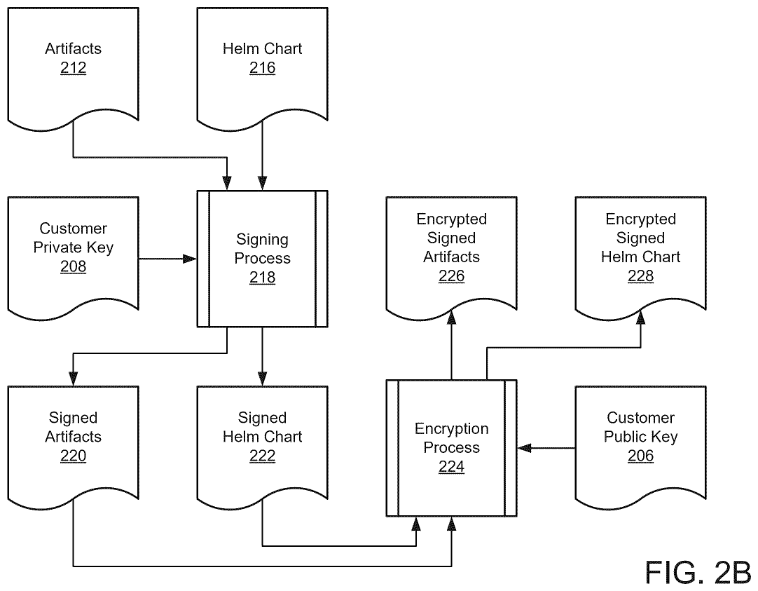

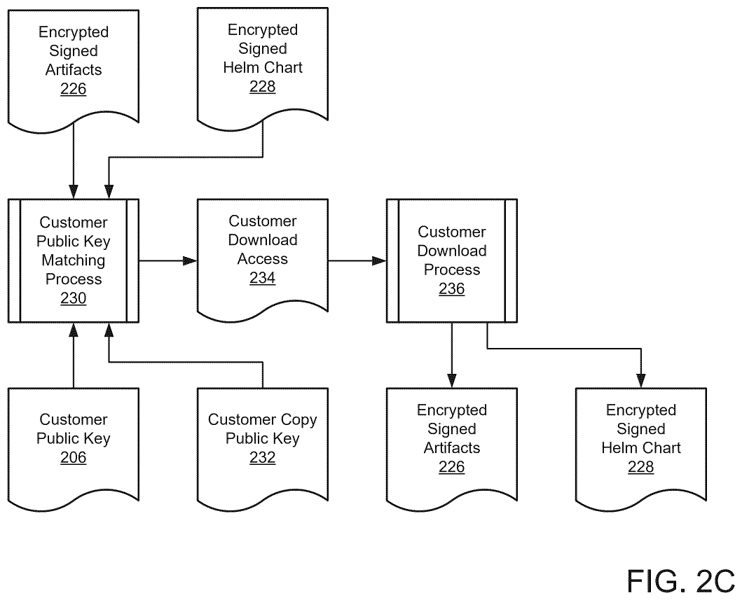

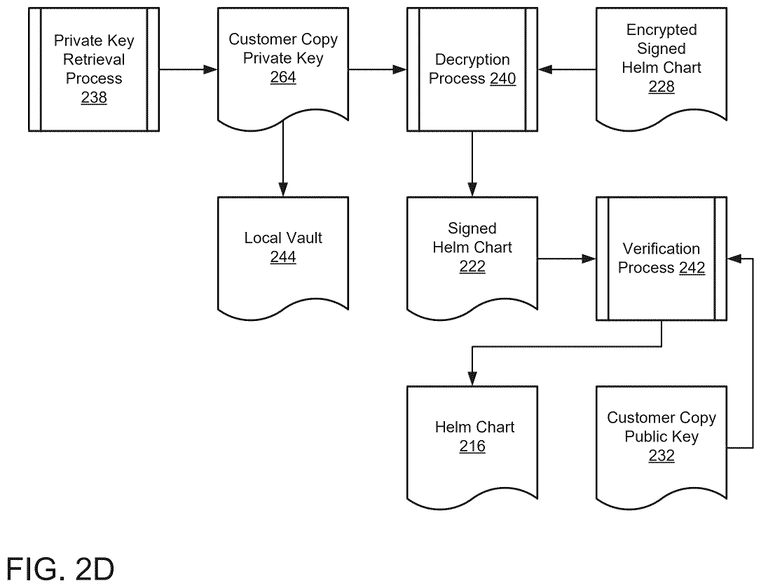

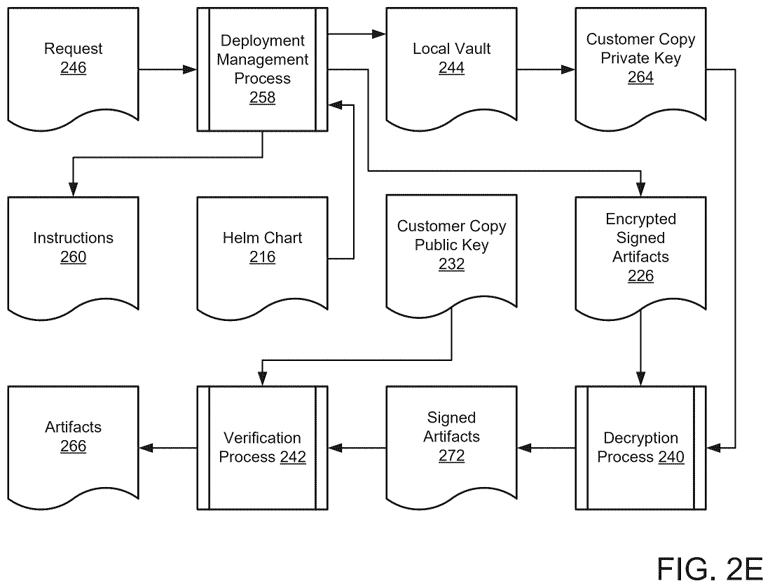

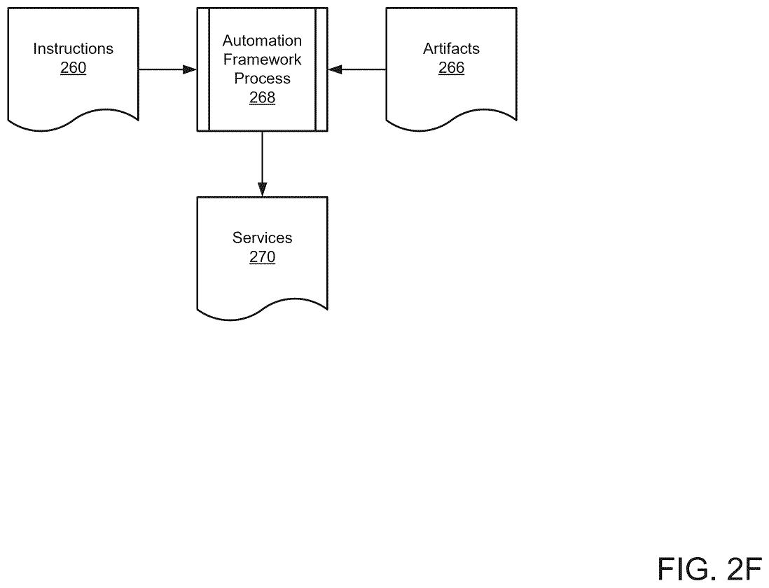

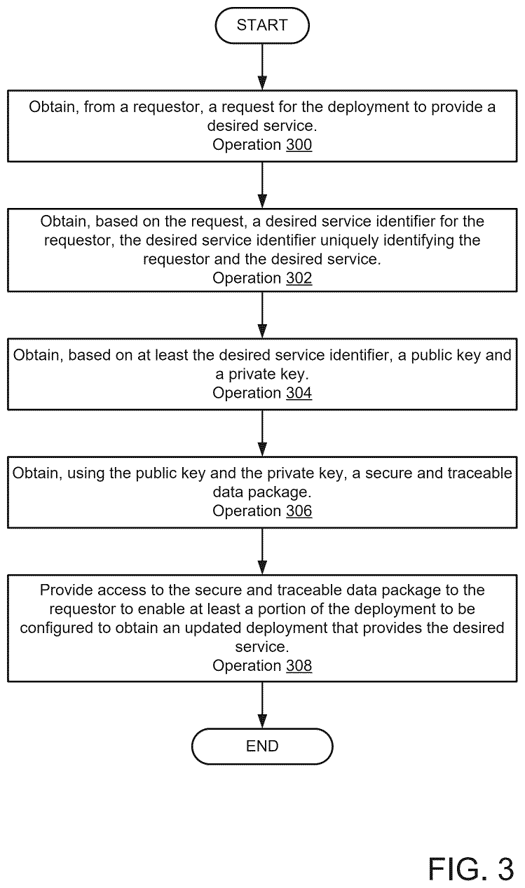

While providing their functionality, any of deployment 100 and edge management system 104 may perform all, or a portion, of the flows and methods shown in FIGS. 2A-3.

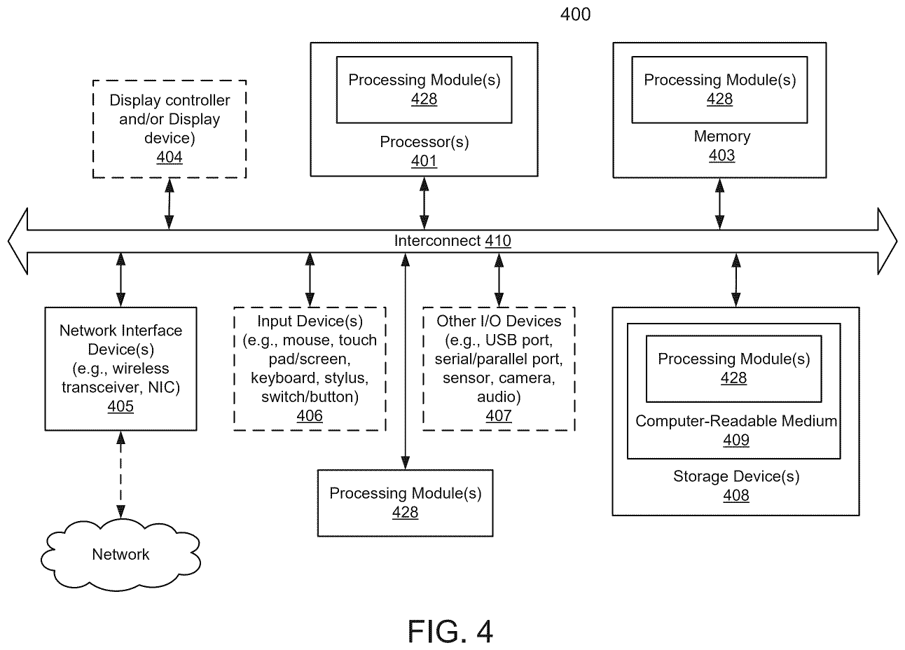

Any of (and/or components thereof) deployment 100 and edge management system 104 may be implemented using a computing device (also referred to as a data processing system) such as a host or a server, a personal computer (e.g., desktops, laptops, and tablets), a “thin” client, a personal digital assistant (PDA), a Web enabled appliance, a mobile phone (e.g., Smartphone), an embedded system, local controllers, an edge node, and/or any other type of data processing device or system. For additional details regarding computing devices, refer to FIG. 4.

Any of the components illustrated in FIG. 1 may be operably connected to each other (and/or components not illustrated) with communication system 102. In an embodiment, communication system 102 includes one or more networks that facilitate communication between any number of components. The networks may include wired networks and/or wireless networks (e.g., and/or the Internet). The networks may operate in accordance with any number and types of communication protocols (e.g., such as the Internet protocol).

While illustrated in FIG. 1 as including a limited number of specific components, a system in accordance with an embodiment may include fewer, additional, and/or different components than those components illustrated therein.

To further clarify embodiments disclosed herein, data flow diagrams in accordance with an embodiment are shown in FIGS. 2A-2F. In these diagrams, flows of data and processing of data are illustrated using different sets of shapes. A first set of shapes (e.g., 202, 206, etc.) is used to represent data structures, a second set of shapes (e.g., 200, 204, etc.) is used to represent processes performed using and/or that generate data, and a third set of shapes (e.g., 210, etc.) is used to represent large scale data structures such as databases.

Turning to FIG. 2A, a first data flow diagram in accordance with an embodiment is shown. The first data flow diagram may illustrate data used in and data processing performed in obtaining artifacts and generating a helm ownership identification, a public key, and a private key.

To obtain the artifacts and generate the helm ownership identification, the public key, and the private key, customer order process 200 may be performed. During customer order process 200, a customer may order software from a vendor necessary to perform computer implemented services by a deployment. The customer may order software by placing an order on the vendor website for a software license.

Once the order is processed, helm ownership ID 202 may be generated. Helm ownership ID 202 may be a digital identification that associates the customer to the order. Helm ownership ID 202 may be ingested by key generation process 204. During key generation process 204, customer public key 206 and customer private key 208 may be generated. Customer public key 206 and customer private key 208 may be generated by an encryption methodology, including Rivest-Shamir-Adleman, elliptic curve cryptography, etc. The customer may be associated with customer public key 206 and customer private key 208 through helm ownership ID 202. For example, helm ownership ID 202 may be a random seed number used for generating customer public key 206 and customer private key 208.

In addition to generating customer public key 206 and customer private key 208, a list of artifacts may be generated during customer order process 200. The list of artifacts may be passed to artifact repository 210. Artifact repository 210 may read the list of the artifacts and select each artifact from artifact repository 210. Artifacts 212 may be obtained from the selection of each artifact from artifact repository 210.

Artifacts 212 may be selected to be used in performing computer implemented services by a deployment. Artifacts 212 may include executable code, configurations, libraries, and/or container applications. Artifacts 210 may be configured to be used by helm chart 216 that is generated from helm chart generation process 214.

During helm chart generation process 214, a configuration package that utilizes artifacts 212 may be written. The configuration package may be helm chart 216. Helm chart 216 may automate configuring, installing, and managing container applications. Configuring may include setting system variables that are used manage container applications. Container applications may perform computer implemented services on any number of edge device 100B-100N. Container applications may be managed by modifying configuration values in templates as necessary. The configuration values may determine, for example, resources used by the container applications, environment variables, etc. In addition, helm ownership ID 202 may be recorded as metadata in helm chart 216 to associate helm chart 216 with helm ownership ID 202.

Thus, via the data flow illustrated in FIG. 2A, a system in accordance with an embodiment may obtain artifacts and generate a helm ownership identification, a public key, and a private key. Consequently, a deployment (e.g., 100) may be more likely to be able to provide desired computer implemented services by having necessary components for a deployment (e.g., 100) be generated by a vendor.

Turning to FIG. 2B, a second data flow diagram in accordance with an embodiment is shown. The second data flow diagram may illustrate data used in and data processing performed in signing and encrypting artifacts and a helm chart.

To sign artifacts 212 and helm chart 216, signing process 218 may be performed. During signing process 218, an artifact of artifacts 212 may be ingested by a hash function. As a result of the ingestion, a digest may be generated. The digest may be a hash value of the artifact. Using customer private key 208, the hash value of the artifact may be encrypted. An encrypted hash value of the artifact may be a digital signature. The digital signature may be appended to the artifact. During signing process 218, a digital signature may also be generated and appended to helm chart 216. In this way, signed artifacts 220 and signed helm chart 222 may be generated.

To encrypt signed artifacts 220 and signed helm chart 222, signed artifacts 220 and signed helm chart 222 may be ingested during encryption process 224. During encryption process 224, a signed artifact of signed artifacts 220 may be ingested by an encryption methodology such as Rivest-Shamir-Adleman, elliptic curve cryptography, etc. with customer public key 206. As a result of the ingestion, encrypted signed artifacts 226 may be generated. Similarly, signed helm chart 222 may be ingested in encryption process 224 to generate encrypted signed helm chart 228.

Thus, via the data flow illustrated in FIG. 2B, a system in accordance with an embodiment may sign and encrypt artifacts and a helm chart. Consequently, a deployment (e.g., 100) may be more likely to be able to provide desired computer implemented services by having components for a deployment (e.g., 100) be signed and encrypted by a vendor.

Turning to FIG. 2C, a third data flow diagram in accordance with an embodiment is shown. The third data flow diagram may illustrate data used in and data processing performed in transferring encrypted signed artifacts and an encrypted signed helm chart from the vendor to a customer.

To transfer encrypted signed artifacts 226 and encrypted signed helm chart 228, customer public key matching process 230 may be performed. During customer public key matching process 230, a confirmation may take place before allowing the customer access to encrypted signed artifacts 226 and encrypted signed helm chart 228. The confirmation may take place by matching customer public key 206 from the vendor with customer copy public key 232 from the customer. Customer copy public key 232 may be a copy of customer public key 206 that was received by the customer from the vendor after generation of customer public key 206.

To match customer public key 206 to customer copy public key 232, first bits of customer public key 206 may be ingested into a hash function to generate a first hash string. Next, second bits of customer copy public key 232 may be ingested into a hash function to generate a second hash string. If the first hash string matches the second hash string, then customer public key 206 may match customer copy public key 232.

If customer public key 206 matches customer copy public key 232, then customer download access 234 may be granted. Customer download access 234 may include (i) validation of an internet protocol address of the customer, (ii) validation of helm ownership ID 202 associated with the customer, (iii) granted access to a secure location on a vendor website, etc.

Once customer download access 234 has been granted, customer download process 236 may be performed. During customer download process 236, the customer may be permitted by the vendor to download encrypted signed artifacts 226 and encrypted signed helm chart 228 from the secure location on the vendor website. By downloading, the customer may obtain encrypted signed artifacts 226 and encrypted signed helm chart 228 for use in a deployment (e.g., 100).

Thus, via the data flow illustrated in FIG. 2C, a system in accordance with an embodiment may permit obtaining of signed and encrypted artifacts and a signed and encrypted helm chart. Consequently, a deployment (e.g., 100) may be more likely to be able to provide desired computer implemented services by securely obtaining the signed and encrypted artifacts and the signed and encrypted helm chart from the vendor.

Turning to FIG. 2D, a fourth data flow diagram in accordance with an embodiment is shown. The fourth data flow diagram may illustrate data used in and data processing performed in obtaining a private key and decrypting and verifying a helm chart.

To obtain customer copy private key 264, private key retrieval process 238 may be performed. During private key retrieval process 238, a customer may access a secure location, which is similar or different than where, as described for FIG. 2C, encrypted signed artifacts 226 and encrypted signed helm chart 228 are stored by a vendor.

The customer may access the secure location by (i) obtaining permission to access the secure location and (ii) downloading customer copy private key 264 from the secure location. Permission to access the secure location may be obtained by (i) confirming the value of helm ownership ID 202 associated with customer copy private key 264, (ii) matching customer public key 206 with customer copy public key 232 similar to customer public key matching process 230, described in FIG. 2C, etc.

Once customer copy private key 264 is obtained, customer copy private key 264 may be stored in local vault 244. Local vault 244 may be a secure location facilitated by the customer. Local vault 244 may include a hardware security module, encrypted cloud storage, a secure shell agent, a virtual private network, etc. Customer copy private key 264 may be accessible by the customer when needed.

Using customer copy private key 264, decryption process 240 may be performed. During decryption process 240, encrypted signed helm chart 228 may be decrypted by the customer. Encrypted signed helm chart 228 may be decrypted by ingesting encrypted signed helm chart 228 with customer copy private key 264 in an encryption methodology that was used to encrypt signed helm chart 222 during encryption process 224. Signed helm chart 222 may be obtained from decryption process 240.

Finally, signed helm chart 222 may need to be verified for authenticity from the vendor. Signed helm chart 222 may be verified during verification process 242. Signed helm chart 222 may be verified by (i) generating a first hash value of signed helm chart 222, (ii) obtaining a second hash value of a digital signature in signed helm chart 222, and (iii) matching the first hash value with the second hash value.

The first hash value may be obtained by ingesting a helm chart of signed helm chart 222 in a hash function. An output of the hash function is the first hash value. The second hash value may be obtained by decrypting the digital signature in signed helm chart 222 with customer copy public key 232. Decryption of the digital signature with customer copy public key 232 may generate the second hash value. If the first hash value matches the second hash value, then the customer may be confident that signed helm chart 222 includes helm chart 216.

Thus, via the data flow illustrated in FIG. 2D, a system in accordance with an embodiment may permit obtaining a private key and decrypting and verifying a helm chart. Consequently, a deployment (e.g., 100) may be more likely to be able to provide desired computer implemented services by securely obtaining the private key and decrypting and verifying the helm chart from the vendor.

Turning to FIG. 2E, a fifth data flow diagram in accordance with an embodiment is shown. The fifth data flow diagram may illustrate data used in and data processing performed in generating instructions for services and selecting artifacts to perform the instructions.

To generate the instructions and select the artifacts, request 246 may be made. Request 246 may be a call for a service by a user and/or software on a data processing system. To make the call for the service, request 246 may be ingested by deployment management process 258.

During deployment management process 258, request 246 may be read. Helm chart 216 may also be read to find available resources to complete request 246. The available resources may include applications that are run by one or more artifacts. During deployment management process 258, the one or more artifacts may be identified.

The one or more artifacts may be identified by instructions 260. Instructions 260 may be generated during deployment management process 258. Instructions 260 may be generated by (i) searching helm chart 216 for a service template, (ii) on finding the service template, reading a configuration for the service template, and (iii) retrieving instructions 260, based on the configuration, to run a deployed service. Instructions 260 may include a list of artifacts to use to perform the service. Once the one or more artifacts are identified to complete request 246, local vault 244 may be accessed.

Local vault 244 may be accessed by a request. The steps of the request may be written in a deployment manifest. The deployment manifest may be a configuration file that defines a desired state of a resource from deployment management process 258. The request may require access to local vault 244 to use customer copy private key 264.

During deployment management process 258, encrypted signed artifacts 226 may be selected. Encrypted signed artifacts 226 may be selected from the available resources in helm chart 216 to perform the service according to request 246. Encrypted signed artifacts 226 may include container applications that can perform the service. Encrypted signed artifacts 226 may be decrypted with customer copy private key 264 during decryption process 240.

Using customer copy private key 264, decryption process 240 may be performed. During decryption process 240, encrypted signed artifacts 226 may be decrypted. Encrypted signed helm chart 228 may be decrypted by ingesting encrypted signed artifacts 226 with customer copy private key 264 in an encryption methodology that was used to encrypt signed artifacts 220 during encryption process 224. Signed artifacts 272 may be obtained from decryption process 240.

Finally, signed artifacts 272 may need to be verified for authenticity. Signed artifacts 272 may be verified during verification process 242. Signed artifacts 272 may be verified by (i) generating a first hash value of an artifact of signed artifacts 272, (ii) obtaining a second hash value of a digital signature in signed artifacts 272, and (iii) matching the first hash value with the second hash value.

The first hash value may be obtained by ingesting the artifact of signed artifacts 272 in a hash function. An output of the hash function is the first hash value. The second hash value may be obtained by decrypting the digital signature in signed artifacts 272 with customer copy public key 232. Decryption of the digital signature with customer copy public key 232 may generate the second hash value. If the first hash value matches the second hash value, then the customer may be confident that signed artifacts 272 includes artifacts 266. Artifacts 266 may be a portion of artifacts 212 from the description of FIG. 2B.

Thus, via the data flow illustrated in FIG. 2E, a system in accordance with an embodiment may generate instructions for services and select artifacts to perform the instructions. Consequently, a deployment (e.g., 100) may be more likely to be able to provide desired computer implemented services by using a helm chart to generate the instructions for the services and decrypting and verifying authenticity of artifacts used in the services.

Turning to FIG. 2F, a sixth data flow diagram in accordance with an embodiment is shown. The sixth data flow diagram may illustrate data used in and data processing performed in performing services.

To perform the services, automation framework process 268 may be performed. During automation framework process 268, instructions 260, detailed in the description of FIG. 2E, may be ingested. Instructions 260 may be parsed to understand what actions need to be performed. The actions may be mapped to specific methods and/or commands. A sequence of the methods and/or the commands may be generated that include services 270.

Artifacts 266, from the description of FIG. 2E, may be assigned to one or more data processing systems to perform services 270. Services 270 may include the sequence of methods and/or the commands that may be performed. Services 270 may include tasks involving data ingestion, data storage, data cleaning and transformation, data analysis, data backup, etc.

Thus, via the data flow illustrated in FIG. 2F, a system in accordance with an embodiment may perform services using artifacts and instructions. Consequently, a deployment (e.g., 100) may be more likely to be able to provide desired computer implemented services by following the instructions and using the artifacts that have been securely provided from a vendor.

Any of the processes illustrated using the second set of shapes may be performed, in part or whole, by digital processors (e.g., central processors, processor cores, etc.) that execute corresponding instructions (e.g., computer code/software). Execution of the instructions may cause the digital processors to initiate performance of the processes. Any portions of the processes may be performed by the digital processors and/or other devices. For example, executing the instructions may cause the digital processors to perform actions that directly contribute to performance of the processes, and/or indirectly contribute to performance of the processes by causing (e.g., initiating) other hardware components to perform actions that directly contribute to the performance of the processes.

Any of the processes illustrated using the second set of shapes may be performed, in part or whole, by special purpose hardware components such as digital signal processors, application specific integrated circuits, programmable gate arrays, graphics processing units, data processing units, and/or other types of hardware components. These special purpose hardware components may include circuitry and/or semiconductor devices adapted to perform the processes. For example, any of the special purpose hardware components may be implemented using complementary metal-oxide semiconductor based devices (e.g., computer chips).

Any of the data structures illustrated using the first and third set of shapes may be implemented using any type and number of data structures. Additionally, while described as including particular information, it will be appreciated that any of the data structures may include additional, less, and/or different information from that described above. The informational content of any of the data structures may be divided across any number of data structures, may be integrated with other types of information, and/or may be stored in any location.

As discussed above, the components of FIG. 1 may perform various methods to manage operation of a deployment. FIG. 3 illustrates a method that may be performed by the components of the system of FIG. 1. In the diagram discussed below and shown in FIG. 3, any of the operations may be repeated, performed in different orders, and/or performed in parallel with or in a partially overlapping in time manner with other operations.

Turning to FIG. 3, a flow diagram illustrating a method of managing operation of a deployment in accordance with an embodiment is shown. The method may be performed, for example, by any of the components of the system of FIG. 1, and/or other components not shown therein.

At operation 300, a request may be obtained from a requestor for the deployment to provide a desired service. The request may be obtained by receiving the request from the requestor.

At operation 302, a desired service identifier may be obtained, based on the request, for the requestor, the desired service identifier uniquely identifying the requestor and the desired service. The desired service identifier may be obtained by generating the desired service identifier based on a random seed generation and/or details of requestor and/or the desired service.

At operation 304, a public key and a private key may be obtained, based on the desired service identifier. The public key and the private key may be obtained by generating the public key and the private key using a cryptographic algorithm with the desired service identifier used as a random seed for key generation.

At operation 306, a secure and traceable data package may be obtained using the public key and the private key. The secure and traceable data package may be obtained by (i) obtaining, based on the desired service, a desired state chart for at least one artifact; (ii) obtaining, based on the desired service, the at least one artifact; (iii) signing, using the private key, the desired state chart and the at least one artifact to obtain a signed desired state chart and a signed at least one artifact; and (iv) encrypting, using the public key, at least the signed desired state chart and the signed at least one artifact to obtain the secure and traceable data package.

The desired state chart may be obtained by generating a configuration package that utilizes artifacts to perform services on at least one data processing system. At least one artifact may be obtained by assigning the at least one artifact to the desired state chart from an artifact repository. The desired state chart and the at least one artifact may be signed by (i) assigning a first hash value of the desired state chart to the desired state chart and (ii) assigning a second hash value of the at least one artifact to the at least one artifact. The desired state chart and the at least one artifact may be encrypted by (i) ingesting the desired state chart with the public key to obtain an encrypted desired state chart and (ii) ingesting the at least one artifact with the public key to obtain an at least one encrypted artifact.

In addition, to the requestor, secure access may be provided to the private key to enable the secure and traceable data package to be decrypted. The secure access may be provided by storing the private key in a secure location to be accessible only by the requestor. The private key may be stored in a secure location by (i) choosing the secure location and (ii) depositing the private key in the secure location.

At operation 308, access may be provided to the secure and traceable data package to the requestor to enable at least a portion of the deployment to be configured to obtain an updated deployment that provides the desired service. The access may be provided by (i) providing the public key to the requestor and (ii) depositing the encrypted desired service chart and the at least one encrypted artifact in a second secure location. The requestor may obtain the encrypted desired service chart and the at least one encrypted artifact using a means of verification involving the desired service identifier and/or the public key.

The method may end following operation 308.

Thus, via the method shown in FIG. 3, embodiments herein may likely improve a likelihood of managing operation of a deployment. By improving the likelihood of managing operation of the deployment, the data processing systems may be more likely to provide desirable computer implemented services by, for example providing a secure and traceable data package to a requestor; ensuring, through encryption and signing methods, components of the secure and traceable data package cannot be used by unauthorized users, etc.

Any of the components illustrated in FIGS. 1-2F may be implemented with one or more computing devices. Turning to FIG. 4, a block diagram illustrating an example of a data processing system (e.g., a computing device) in accordance with an embodiment is shown. For example, system 400 may represent any of data processing systems described above performing any of the processes or methods described above. System 400 can include many different components. These components can be implemented as integrated circuits (ICs), portions thereof, discrete electronic devices, or other modules adapted to a circuit board such as a motherboard or add-in card of the computer system, or as components otherwise incorporated within a chassis of the computer system. Note also that system 400 is intended to show a high level view of many components of the computer system. However, it is to be understood that additional components may be present in certain implementations and furthermore, different arrangement of the components shown may occur in other implementations. System 400 may represent a desktop, a laptop, a tablet, a server, a mobile phone, a media player, a personal digital assistant (PDA), a personal communicator, a gaming device, a network router or hub, a wireless access point (AP) or repeater, a set-top box, or a combination thereof. Further, while only a single machine or system is illustrated, the term “machine” or “system” shall also be taken to include any collection of machines or systems that individually or jointly execute a set (or multiple sets) of instructions to perform any one or more of the methodologies discussed herein.

In one embodiment, system 400 includes processor 401, memory 403, and devices 405-407 via a bus or an interconnect 410. Processor 401 may represent a single processor or multiple processors with a single processor core or multiple processor cores included therein. Processor 401 may represent one or more general-purpose processors such as a microprocessor, a central processing unit (CPU), or the like. More particularly, processor 401 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. Processor 401 may also be one or more special-purpose processors such as an application specific integrated circuit (ASIC), a cellular or baseband processor, a field programmable gate array (FPGA), a digital signal processor (DSP), a network processor, a graphics processor, a network processor, a communications processor, a cryptographic processor, a co-processor, an embedded processor, or any other type of logic capable of processing instructions.

Processor 401, which may be a low power multi-core processor socket such as an ultra-low voltage processor, may act as a main processing unit and central hub for communication with the various components of the system. Such processor can be implemented as a system on chip (SoC). Processor 401 is configured to execute instructions for performing the operations discussed herein. System 400 may further include a graphics interface that communicates with optional graphics subsystem 404, which may include a display controller, a graphics processor, and/or a display device.

Processor 401 may communicate with memory 403, which in one embodiment can be implemented via multiple memory devices to provide for a given amount of system memory. Memory 403 may include one or more volatile storage (or memory) devices such as random access memory (RAM), dynamic RAM (DRAM), synchronous DRAM (SDRAM), static RAM (SRAM), or other types of storage devices. Memory 403 may store information including sequences of instructions that are executed by processor 401, or any other device. For example, executable code and/or data of a variety of operating systems, device drivers, firmware (e.g., input output basic system or BIOS), and/or applications can be loaded in memory 403 and executed by processor 401. An operating system can be any kind of operating systems, such as, for example, Windows® operating system from Microsoft®, Mac OS®/iOS® from Apple, Android® from Google®, Linux®, Unix®, or other real-time or embedded operating systems such as VxWorks.

System 400 may further include IO devices such as devices (e.g., 405, 406, 407, 408) including network interface device(s) 405, optional input device(s) 406, and other optional IO device(s) 407. Network interface device(s) 405 may include a wireless transceiver and/or a network interface card (NIC). The wireless transceiver may be a WiFi transceiver, an infrared transceiver, a Bluetooth transceiver, a WiMax transceiver, a wireless cellular telephony transceiver, a satellite transceiver (e.g., a global positioning system (GPS) transceiver), or other radio frequency (RF) transceivers, or a combination thereof. The NIC may be an Ethernet card.

Input device(s) 406 may include a mouse, a touch pad, a touch sensitive screen (which may be integrated with a display device of optional graphics subsystem 404), a pointer device such as a stylus, and/or a keyboard (e.g., physical keyboard or a virtual keyboard displayed as part of a touch sensitive screen). For example, input device(s) 406 may include a touch screen controller coupled to a touch screen. The touch screen and touch screen controller can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen.

IO devices 407 may include an audio device. An audio device may include a speaker and/or a microphone to facilitate voice-enabled functions, such as voice recognition, voice replication, digital recording, and/or telephony functions. Other IO devices 407 may further include universal serial bus (USB) port(s), parallel port(s), serial port(s), a printer, a network interface, a bus bridge (e.g., a PCI-PCI bridge), sensor(s) (e.g., a motion sensor such as an accelerometer, gyroscope, a magnetometer, a light sensor, compass, a proximity sensor, etc.), or a combination thereof. IO device(s) 407 may further include an imaging processing subsystem (e.g., a camera), which may include an optical sensor, such as a charged coupled device (CCD) or a complementary metal-oxide semiconductor (CMOS) optical sensor, utilized to facilitate camera functions, such as recording photographs and video clips. Certain sensors may be coupled to interconnect 410 via a sensor hub (not shown), while other devices such as a keyboard or thermal sensor may be controlled by an embedded controller (not shown), dependent upon the specific configuration or design of system 400.

To provide for persistent storage of information such as data, applications, one or more operating systems and so forth, a mass storage (not shown) may also couple to processor 401. In various embodiments, to enable a thinner and lighter system design as well as to improve system responsiveness, this mass storage may be implemented via a solid state device (SSD). However, in other embodiments, the mass storage may primarily be implemented using a hard disk drive (HDD) with a smaller amount of SSD storage to act as an SSD cache to enable non-volatile storage of context state and other such information during power down events so that a fast power up can occur on re-initiation of system activities. Also a flash device may be coupled to processor 401, e.g., via a serial peripheral interface (SPI). This flash device may provide for non-volatile storage of system software, including a basic input/output software (BIOS) as well as other firmware of the system.

Storage device 408 may include computer-readable storage medium 409 (also known as a machine-readable storage medium or a computer-readable medium) on which is stored one or more sets of instructions or software (e.g., processing module, unit, and/or processing module/unit/logic 428) embodying any one or more of the methodologies or functions described herein. Processing module/unit/logic 428 may represent any of the components described above. Processing module/unit/logic 428 may also reside, completely or at least partially, within memory 403 and/or within processor 401 during execution thereof by system 400, memory 403 and processor 401 also constituting machine-accessible storage media. Processing module/unit/logic 428 may further be transmitted or received over a network via network interface device(s) 405.

Computer-readable storage medium 409 may also be used to store some software functionalities described above persistently. While computer-readable storage medium 409 is shown in an exemplary embodiment to be a single medium, the term “computer-readable storage medium” should be taken to include a single medium or multiple media (e.g., a centralized or distributed database, and/or associated caches and servers) that store the one or more sets of instructions. The terms “computer-readable storage medium” shall also be taken to include any medium that is capable of storing or encoding a set of instructions for execution by the machine and that cause the machine to perform any one or more of the methodologies of embodiments disclosed herein. The term “computer-readable storage medium” shall accordingly be taken to include, but not be limited to, solid-state memories, and optical and magnetic media, or any other non-transitory machine-readable medium.

Processing module/unit/logic 428, components and other features described herein can be implemented as discrete hardware components or integrated in the functionality of hardware components such as ASICS, FPGAs, DSPs or similar devices. In addition, processing module/unit/logic 428 can be implemented as firmware or functional circuitry within hardware devices. Further, processing module/unit/logic 428 can be implemented in any combination hardware devices and software components.

Note that while system 400 is illustrated with various components of a data processing system, it is not intended to represent any particular architecture or manner of interconnecting the components; as such details are not germane to embodiments disclosed herein. It will also be appreciated that network computers, handheld computers, mobile phones, servers, and/or other data processing systems which have fewer components or perhaps more components may also be used with embodiments disclosed herein.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments disclosed herein also relate to an apparatus for performing the operations herein. Such a computer program is stored in a non-transitory computer readable medium. A non-transitory machine-readable medium includes any mechanism for storing information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices).

The processes or methods depicted in the preceding figures may be performed by processing logic that comprises hardware (e.g. circuitry, dedicated logic, etc.), software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

Embodiments disclosed herein are not described with reference to any particular programming language. It will be appreciated that a variety of programming languages may be used to implement the teachings of embodiments disclosed herein.

In the foregoing specification, embodiments have been described with reference to specific exemplary embodiments thereof. It will be evident that various modifications may be made thereto without departing from the broader spirit and scope of the embodiments disclosed herein as set forth in the following claims. The specification and drawings are, accordingly, to be regarded in an illustrative sense rather than a restrictive sense.

What is claimed is:

1. A method for managing operation of a deployment, the method comprising:
obtaining, from a requestor, a request for the deployment to provide a desired service;
based on the request:
obtaining a desired service identifier for the requestor, the desired service identifier uniquely identifying the requestor and the desired service;
obtaining, based on at least the desired service identifier, a public key and a private key;
obtaining, using the public key and the private key, a secure and traceable data package; and
providing access to the secure and traceable data package to the requestor to enable at least a portion of the deployment to be configured to obtain an updated deployment that provides the desired service.

2. The method of claim 1, wherein obtaining the secure and traceable data package comprises:
obtaining, based on the desired service, a desired state chart for at least one artifact;
obtaining, based on the desired service, the at least one artifact;
signing, using the private key, the desired state chart and the at least one artifact to obtain a signed desired state chart and a signed at least one artifact; and
encrypting, using the public key, at least the signed desired state chart and the signed at least one artifact to obtain the secure and traceable data package.

3. The method of claim 2, further comprising:
providing, to the requestor, secure access to the private key to enable the secure and traceable data package to be decrypted.

4. The method of claim 3, wherein providing the secure access to the private key comprises:
storing the private key in a secure location to be accessible only by the requestor.

5. The method of claim 2, wherein the desired service identifier associates the desired state chart, the public key, and the private key to the requestor.

6. The method of claim 5, wherein the desired state chart is a set of instructions for configuring and managing container applications.

7. The method of claim 2, wherein the at least one artifact comprises executable code, configurations, libraries, or container applications.

8. The method of claim 7, wherein the secure and traceable data package comprises a set of signed and encrypted artifacts and a signed and encrypted desired state chart.

9. A non-transitory machine-readable medium having instructions stored therein, which when executed by a processor, cause the processor to perform operations for managing operation of a deployment, the operations comprising:
obtaining, from a requestor, a request for the deployment to provide a desired service;
based on the request:
obtaining a desired service identifier for the requestor, the desired service identifier uniquely identifying the requestor and the desired service;
obtaining, based on at least the desired service identifier, a public key and a private key;
obtaining, using the public key and the private key, a secure and traceable data package; and
providing access to the secure and traceable data package to the requestor to enable at least a portion of the deployment to be configured to obtain an updated deployment that provides the desired service.

10. The non-transitory machine-readable medium of claim 9, wherein obtaining the secure and traceable data package comprises:
obtaining, based on the desired service, a desired state chart for at least one artifact;
obtaining, based on the desired service, the at least one artifact;
signing, using the private key, the desired state chart and the at least one artifact to obtain a signed desired state chart and a signed at least one artifact; and
encrypting, using the public key, at least the signed desired state chart and the signed at least one artifact to obtain the secure and traceable data package.

11. The non-transitory machine-readable medium of claim 10, wherein the operations further comprise:
providing, to the requestor, secure access to the private key to enable the secure and traceable data package to be decrypted.

12. The non-transitory machine-readable medium of claim 11, wherein providing the secure access to the private key comprises:
storing the private key in a secure location to be accessible only by the requestor.

13. The non-transitory machine-readable medium of claim 10, wherein the desired service identifier associates the desired state chart, the public key, and the private key to the requestor.

14. The non-transitory machine-readable medium of claim 13, wherein the desired state chart is a set of instructions for configuring, installing, and managing container applications.

15. A data processing system, comprising:
a processor; and
a memory coupled to the processor to store instructions, which when executed by the processor, cause the processor to perform operations managing operation of a deployment the operations comprising:
obtaining, from a requestor, a request for the deployment to provide a desired service;
based on the request:
obtaining a desired service identifier for the requestor, the desired service identifier uniquely identifying the requestor and the desired service;
obtaining, based on at least the desired service identifier, a public key and a private key;
obtaining, using the public key and the private key, a secure and traceable data package; and
providing access to the secure and traceable data package to the requestor to enable at least a portion of the deployment to be configured to obtain an updated deployment that provides the desired service.

16. The data processing system of claim 15, wherein obtaining the secure and traceable data package comprises:
obtaining, based on the desired service, a desired state chart for at least one artifact;
obtaining, based on the desired service, the at least one artifact;
signing, using the private key, the desired state chart and the at least one artifact to obtain a signed desired state chart and a signed at least one artifact; and
encrypting, using the public key, at least the signed desired state chart and the signed at least one artifact to obtain the secure and traceable data package.

17. The data processing system of claim 16, wherein the operations further comprise:
providing, to the requestor, secure access to the private key to enable the secure and traceable data package to be decrypted.

18. The data processing system of claim 17, wherein providing the secure access to the private key comprises:
storing the private key in a secure location to be accessible only by the requestor.

19. The data processing system of claim 16, wherein the desired service identifier associates the desired state chart, the public key, and the private key to the requestor.

20. The data processing system of claim 19, wherein the desired state chart is a set of instructions for configuring, installing, and managing container applications.
